(19) United States
(12) Patent Application Publication
(10) Pub. No.: US 2015/0139867 A1
(43) Pub. Date: May 21, 2015

(54) LIQUID MEASURING UNIT AND LIQUID SUPPLYING APPARATUS

(71) Applicant: CANON KABUSHIKI KAISHA, Tokyo (JP)

(72) Inventor: Makoto Ogusu, Hedgerow, VA (US)

(21) Appl. No.: 14/546,871

(22) Filed: Nov. 18, 2014

(30) Foreign Application Priority Data
Nov. 20, 2013 (JP) 2013-240122

(51) Int. Cl. B01L 3/00

(52) U.S. Cl. CPC B01L 3/56
USPC 422/509; 422/501

(57) ABSTRACT

A liquid measuring unit includes a first capillary tube, a second capillary tube, and a holding portion that holds the first capillary tube and the second capillary tube, wherein a distance between a liquid contact portion of the first capillary tube and the holding portion is longer than a distance between a liquid contact portion of the second capillary tube and the holding portion.

### BACKGROUND

1. Field

This disclosure relates to a liquid measuring unit and a liquid supplying apparatus suitable for supplying liquid to a μTAS chip used for obtaining various responses by using a micro flow channel.

1. Description of the Related Art

In recent years, a research development on a technology referred to as a micro total analysis system (μ-TAS) that integrates all elements required for chemical and biochemical analyses on one single chip prevails.

Examples of a method of providing a minute amount of liquid to the μ-TAS by using a capillary force include technologies disclosed in PCT Japanese Translation Patent Publication No. 2009-535635 and PCT Japanese Translation Patent Publication No. 2004-518106.

In PCT Japanese Translation Patent Publication No. 2009-535635, a certain amount of reagent is sucked into a reagent holding portion and held therein by a capillary force, and is caused to response, and a state after the reaction is detected by a light projecting unit and a light receiving unit as an optical signal.

In PCT Japanese Translation Patent Publication No. 2009-535635, a flow channel is filled with a certain amount of liquid by the capillary force, gas is fed thereto, and measured liquid is discharged by a capillary force.

However, in the methods described in the two documents given above, a plurality of different types of liquid can hardly be measured continuously and effectively.

### SUMMARY

This disclosure provides a liquid measuring unit including a first capillary tube, a second capillary tube, and a holding portion configured to hold the first capillary tube and the second capillary tube, wherein a distance between a liquid contact portion of the first capillary tube and the holding portion is longer than a distance between a liquid contact portion of the second capillary tube and the holding portion.

According to this disclosure, a plurality of different types of liquid may be effectively measured.

Further features of the present disclosure will become apparent from the following description of exemplary embodiments with reference to the attached drawings.

### BRIEF DESCRIPTION OF THE DRAWINGS

FIG. 1 is a perspective view of a liquid measuring unit of a first embodiment of this disclosure.

FIG. 2 is a side view of the liquid measuring unit of the first embodiment of this disclosure.

FIG. 3 is a graph showing a comparison between a capillary force which is a force for holding measured liquid and a force applied by an own weight of the measured liquid.

FIG. 4 is a graph showing a result of estimating a volume generated by curving of a liquid interface as a measurement error.

FIG. 5 is a front view of the liquid measuring unit of a second embodiment of this disclosure.

FIG. 6 is a view of the liquid measuring unit of the second embodiment of disclosure viewed from a liquid contact portion.

FIG. 7 is a side view of the liquid measuring unit of a third embodiment of this disclosure.

### DESCRIPTION OF THE EMBODIMENTS

With reference to preferable embodiments, this disclosure will be described.

### First Embodiment

A liquid measuring unit of a first embodiment includes a first capillary tube, a second capillary tube, and a holding portion configured to hold the first capillary tube and the second capillary tube, and is characterized in that a distance between a liquid contact portion of the first capillary tube and the holding portion is longer than a distance between a liquid contact portion of the second capillary tube and the holding portion.

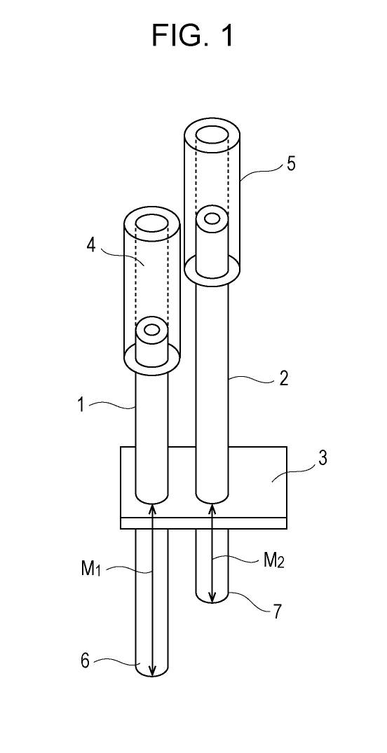

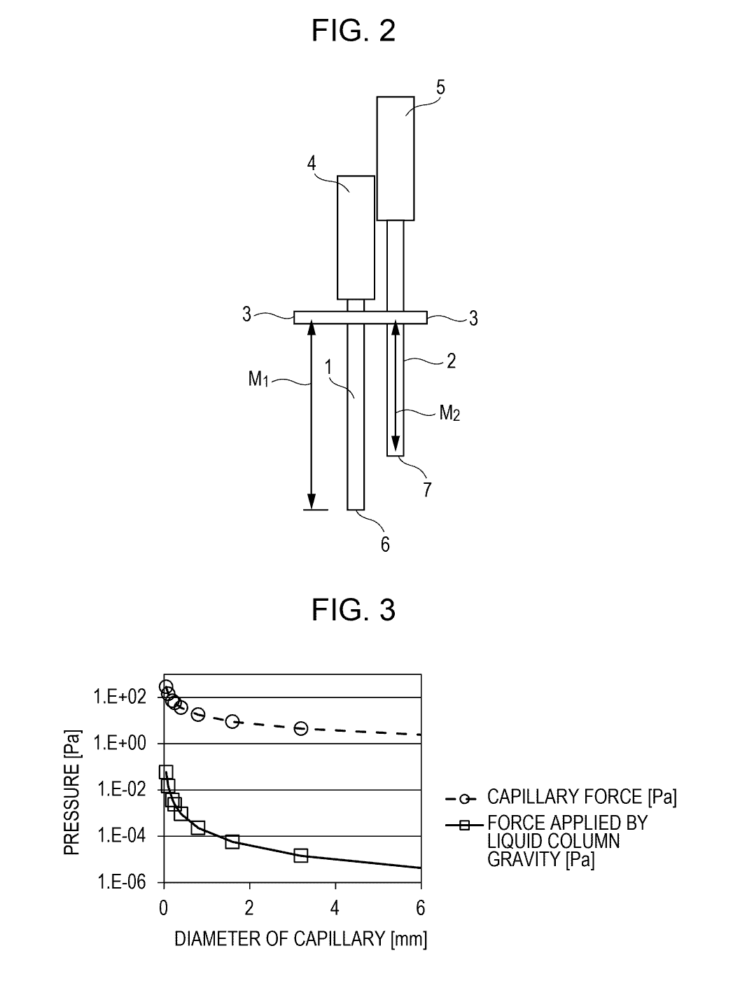

Referring now to FIG. 1 and FIG. 2, the liquid measuring unit of the first embodiment will be described further in detail.

FIG. 1 is a perspective view of the liquid measuring unit of the first embodiment, and FIG. 2 is a side view of the liquid measuring unit of the first embodiment.

In FIG. 1 and FIG. 2, reference numeral 1 denotes a first capillary tube, reference numeral 2 denotes a second capillary tube, reference numeral 3 denotes a holding portion, reference numerals 4 and 5 denote connecting portions, and reference numerals 6 and 7 denote liquid contact portions.

The first capillary tube 1 and the second capillary tube 2 as described above have a column-shaped structure such as a cylindrical shape, and is capable of sucking liquid by a capillary action to measure liquid of sub μL, when the liquid contact portions 6 and 7 are brought into contact with the liquid. Detailed examples of the first capillary tube 1 and the second capillary tube 2 include a capillary. A length of the first capillary tube 1 and a length of the second capillary tube 2 may be the same or different. However, different lengths enable measurement of liquids of different amounts. Here, the liquid contact portion means a portion coming into contact with liquid first when moving the tube downward by the holding portion, and specifically, an end portion of the tube.

The first capillary tube 1 and the second capillary tube 2 preferably have an inner diameter ranging from 0.1 mm to 6 mm. FIG. 3 is a graph showing a comparison between a capillary force which is a force for holding measured liquid and a force applied by an own weight of the measured liquid, assuming a glass tube. In this configuration, with the inner diameter falling within the range from 0.1 mm to 6 mm, the capillary force does not become smaller than the force applied by the own weight of the liquid, so that the stable measured liquid may be held. It is understood that the smaller the inner diameter, the stronger the capillary force.

The first capillary tube 1 and the second capillary tube 2 preferably have hydrophilicity on inner peripheral surfaces thereof, and have water repellency on outer peripheral surfaces thereof. The term “hydrophilicity” described here means that a contact angle of water droplet is less than 90 degrees, and the term “water repellency” means that the contact angle of water droplet is larger than 90 degrees. In general, liquid to be measured is reagent, and has hydrophilicity in many cases. Therefore, when the liquid contact portion of the capillary tube comes into contact with liquid, the liquid is sucked by a capillary force because the inner peripheral surface of the capillary tube has hydrophilicity, whereby the interior of the capillary tube is filled with liquid. When the tube is pulled out from the liquid, liquid is not adhered more than necessary because the outer peripheral surface of the capillary tube has water repellency.

The structure described thus far is achieved by coating a resin having water repellency on an outside of a glass thin tube, for example.

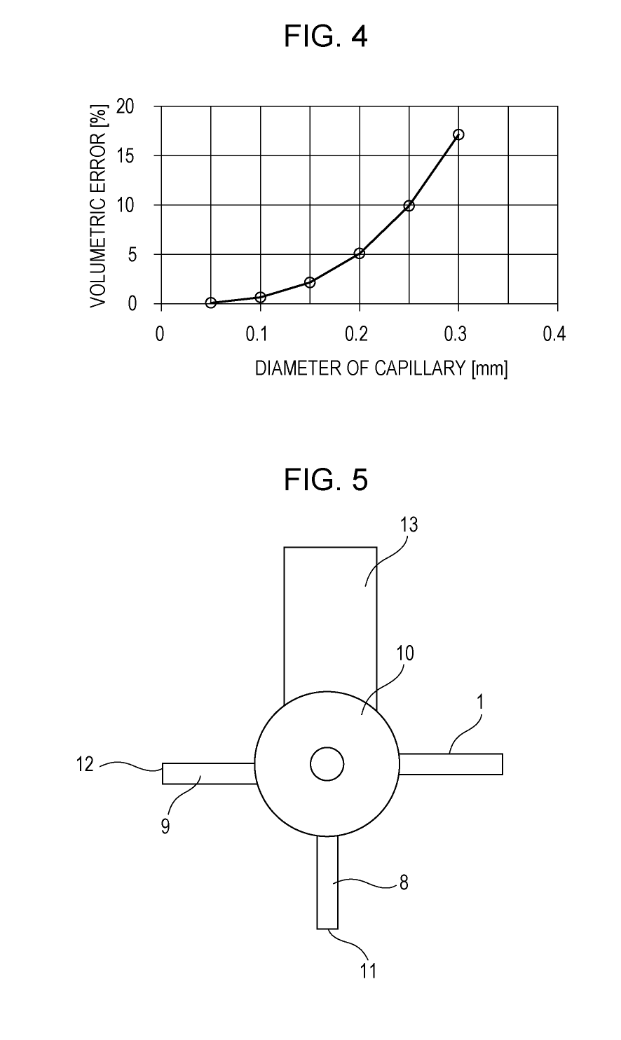

FIG. 4 shows a result of estimating a volume generated by curving of a liquid interface as a measurement error. From FIG. 4, when the inner diameter of the capillary tube is not larger than 0.25 mm, a volumetric error is not more than 10%. Actually, however, a curve similar to the curve of the liquid interface created on an upper surface may be created at a lower portion of the capillary tube, and hence the error may be taken into consideration as an item to be corrected when designing the length of the capillary tube. Therefore, for example, when 0.33 μL, is defined as a liquid amount to be measured, it is supposed that the error is lower than 10% up to the inner diameter of the capillary tube of 1 of 0.25 mm.

A distance M₁ between the liquid contact portion 6 and the holding portion 3 of the first capillary tube 1 is longer than a distance M₂ between the liquid contact portion 7 and the holding portion 3 of the second capillary tube 2.

The state that the distance M₁ is longer than the distance M₂ contributes to allow the placement a liquid surface of a first liquid between the liquid contact portion 6 of the first capillary tube 1 and the liquid contact portion 7 of the second capillary tube 2 when measuring the first liquid by using the first capillary tube 1, so that the liquid may be measured only by the first capillary tube 1. The distances M₁ and M₂ described here indicate the shortest distance between the liquid contact portion of the capillary tube and the holding portion. Therefore, the distance M₁ corresponds to the shortest distance between the liquid contact portion 6 and the holding portion 3, and the distance M₂ corresponds to the shortest distance between the liquid contact portion 7 and the holding portion 3.

The first capillary tube 1 is preferably connected to a discharge mechanism (not illustrated) via the connecting portion 4 present on a side of the first capillary tube 1 opposite to the liquid contact portion 6. In the same manner, the second capillary tube 2 is preferably connected to the discharge mechanism via the connecting portion 5 present on the side of the second capillary tube 2 opposite to the liquid contact portion 7.

The discharge mechanism is used for discharging liquid measured by the capillary tube to an object. The discharge mechanism is preferably a resilient member capable of changing in volume, such as a rubber tube. The reason is that, since the capillary force for measuring liquid is minute, moderate and reliable discharge is possible by discharging on the basis of a volume control rather than a pressure control.

When the discharge mechanism is formed of a resilient member capable of changing in volume, the volumetric change of the discharge mechanism is transmitted to the capillary tube via the connecting portion by deforming the discharge mechanism, whereby the measured liquid is discharged from the tube depending on the volumetric change of the discharge mechanism.

The liquid measuring unit of the first embodiment, a lifting and lowering mechanism configured to lift and lower the liquid measuring unit, a lifting and lowering control unit configured to control the lifting and lowering mechanism, the discharge mechanism connected to the connecting portion, and a discharge mechanism control unit configured to control the discharge mechanism constitute part of the liquid supplying apparatus.

Examples of the lifting and lowering mechanism of the liquid supplying apparatus as described above include a robot arm. Examples of the lifting and lowering control unit and the discharge control unit include a control board such as a motor.

A method of measuring liquid by using the liquid measuring unit of the first embodiment will be described below.

The liquid measuring unit is brought into contact with the first liquid so that the liquid surface of the first liquid is placed between the liquid contact portion 6 of the first capillary tube 1 and the liquid contact portion 7 of the second capillary tube 2, and the first liquid is measured only by the first capillary tube 1 with the capillary force thereof.

Subsequently, the position of the liquid measuring unit is lowered by using the holding portion 3, the liquid measuring unit and a second liquid (liquid different from the first liquid) are brought into contact with each other to bring a liquid surface of the second liquid to be present between the liquid contact portion 7 of the second capillary tube 2 and the holding portion 3, whereby the second liquid is measured by the second capillary tube 2. At this time, the first capillary tube 1 comes into contact with the second liquid as well. However, since the interior of the first capillary tube 1 is already filled with the first liquid, the second liquid can be filled only little. The measured first liquid in the first capillary tube 1 is held in the first capillary tube 1 by the capillary force and hence is discharged little into the second liquid. A main surface of the holding portion 3 is preferably arranged perpendicularly with respect to a center axis of the first capillary tube 1 and a center axis of the second capillary tube 2. The reason is that tube can be brought into contact with the liquid surface of the liquid easily with the arrangement of the holding portion in this manner.

In this manner, the liquid measuring unit of the first embodiment is allowed to perform measurement continuously by moving the liquid measuring unit in a perpendicular direction, so that effective measurement of a plurality of liquids is achieved.

The measured liquid is discharged to a specimen such as an object of analysis by the discharge mechanism (not illustrated) connected to the connecting portions 4 and 5 of the liquid measuring unit.

An end of the discharge mechanism on a side opposite to a side where the first capillary tube 1 and the second capillary tube 2 are connected may either be in an opened state or in a closed state. When the end of the discharge mechanism is in the opened state, the volumetric change in the tube occurring when the tube sucks liquid with the capillary force can hardly induce a pressure change, and hence a stable measuring operation may be expected. In such a case, when discharging the liquid by the volumetric change of the discharge mechanism, the end in the opened state is closed by the deformation of the discharge mechanism, and in this state, an operation of discharging the liquid by an operation of reducing the volume is performed.

In contrast, when the end of the discharge mechanism is in the closed state, the measured liquid may be discharged by deforming the discharge mechanism, and hence the operation of the mechanism of the volumetric change may be simplified. When the liquid of 0.33 μL, is sucked by using the glass tube having an inner diameter of 0.25 mm, for example, is seems that the volumetric change as much as impairing the capillary force does not occur by using a tube formed of a resilient member having an inner diameter of 5 mm and a length of 34 mm as a discharging mechanism.

In the first embodiment, a mode in which the liquid measuring unit is composed of the first capillary tube 1 and the second capillary tube 2 has been descried. However, the liquid measuring unit of this disclosure may include a third capillary tube. In the case where the third capillary tube is included, it is preferable that the third capillary tube is present adjacently to the first capillary tube or the second capillary tube. In such a case, a distance M₃ from a liquid contact portion of the third capillary tube to the holding portion may be the same as or different from the distance M₁ between the liquid contact portion 6 of the first capillary tube 1 and the holding portion 3 and the distance M₂ between the liquid contact portion 7 of the second capillary tube 2 and the holding portion 3. However, if it is the same, the third capillary tube is preferably provided adjacently to the capillary tube the distance between the liquid contact portion and the holding portion of which is the same as that of the third capillary tube. With the adjacent arrangement, even when the amount of liquid to be measured is minute and hence the area where the liquid exist is narrow, the liquid may be measured at a time with the capillary tubes having the same distance. If the distances are different from each other, the tubes are preferably arranged in a descending order or an ascending order in terms of the distance.

For example, the distance M₃ between the liquid contact portion of the third capillary tube and the holding portion is shorter than M₁ and M₂, a relationship,

M₁>M₂ >M₃ Expression 1

is satisfied. Therefore, an arrangement of the first capillary tube, the second capillary tube, and the third capillary tube in this order is preferable.

When the liquid measuring unit includes the third capillary tube, the third capillary tube also preferably has a connecting portion to be connected to the discharge mechanism on a side opposite to the liquid contact portion.

### Second Embodiment

The liquid measuring unit of a second embodiment includes a first capillary tube, a second capillary tube, and a holding portion configured to hold the first capillary tube and the second capillary tube and having a rotary mechanism configured to rotate the first capillary tube and the second capillary tube.

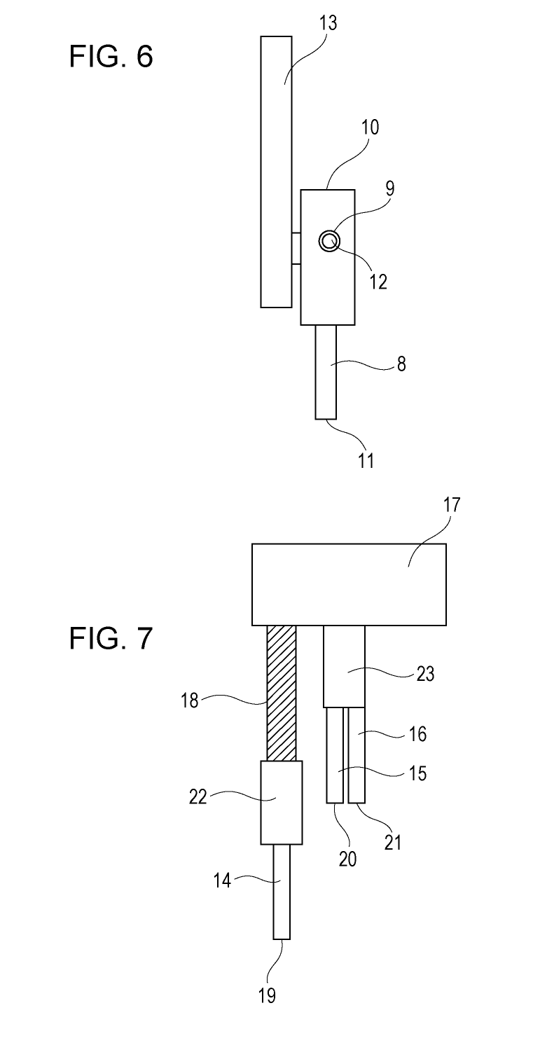

Referring now to FIG. 5 and FIG. 6, the liquid measuring unit of the second embodiment will be described. Description of portions common to the liquid measuring unit of the first embodiment will be omitted.

FIG. 5 is a front view of the liquid measuring unit of the second embodiment, and FIG. 6 illustrates the liquid measuring unit of the second embodiment viewed from the liquid contact portion.

In FIG. 5 and FIG. 6, reference numeral 8 denotes a first capillary tube, reference numeral 9 denotes a second capillary tube, reference numeral 10 denotes a holding portion having a rotary mechanism, reference numerals 11 and 12 denote liquid contact portions, and reference numeral 13 denotes a lifting and lowering mechanism.

The first capillary tube 8 and the second capillary tube 9 are fixed to the holding portion 10 having the rotary mechanism at positions apart from each other.

The holding portion 10 having the rotary mechanism is rotated at a desired angle, a capillary tube that is to be used for measurement is selected, and the lifting and lowering mechanism 13 lowers the selected capillary tube to a liquid surface of liquid, comes into contact with the liquid, and measures the liquid. The holding portion 10 rotates the first capillary tube 8 and the second capillary tube 9 about an axis of rotation of the rotary mechanism. The discharge mechanism, which is not illustrated, and the connecting portion connected to the discharge mechanism are the same as those of the first embodiment. The connecting portion is present in the interior of the holding portion 10 having the rotary mechanism.

The liquid supplying apparatus having the liquid measuring unit of the second embodiment includes the liquid measuring unit of the second embodiment, a lifting and lowering mechanism configured to lift and lower the liquid measuring unit, a lifting and lowering control unit configured to control the lifting and lowering mechanism, a rotation control unit configured to control the rotary mechanism provided on the holding portion, a discharge mechanism to be connected to the connecting portion, and a discharge mechanism control unit configured to control the discharge mechanism. The rotation control unit and the lifting and lowering control unit control the lifting and lowering mechanism and the rotary mechanism provided on the holding portion, whereby the liquid may be measured by using the selected tube.

Examples of the rotation control unit include a control board such as a motor. The lifting and lowering mechanism, the lifting and lowering control unit, the discharge mechanism, and the discharge mechanism control unit are the same as those of the first embodiment.

The liquid measuring unit of the second embodiment includes the first capillary tube and the second capillary tube. However, the liquid measuring unit of this disclosure may include a third capillary tube may be provided in addition to the first capillary tube and the second capillary tube. When the liquid measuring unit of this disclosure includes the third capillary tube, the third capillary tube may be present adjacently to the first capillary tube or the second capillary tube, or alternatively, the first capillary tube, the second capillary tube, and the third capillary tube may be provided apart from each other.

### Third Embodiment

The liquid measuring unit of a third embodiment includes a first capillary tube, a second capillary tube, a third capillary tube present adjacently to the second capillary tube, a first lifting and lowering mechanism configured to lift and lower the first capillary tube, a second lifting and lowering mechanism configured to lift and lower the second capillary tube and the third capillary tube, and a holding portion configured to hold the first lifting and lowering mechanism and the second lifting and lowering mechanism.

Referring now to FIG. 7, the liquid measuring unit of the third embodiment will be described. Description of portions common to the liquid measuring unit of the first embodiment will be omitted.

FIG. 7 is a front view of the liquid measuring unit of the third embodiment.

In FIG. 7, reference numeral 14 denotes a first capillary tube, reference numeral 15 denotes a second capillary tube, reference numeral 16 denotes a third capillary tube, reference numerals 19, 20, and 21 denote liquid contact portions, reference numeral 17 denotes a holding portion, reference numeral 18 denotes a lifting and lowering mechanism, and reference numerals 22 and 23 denote connecting portions between the capillary tubes and the lifting and lowering mechanism.

In the liquid measuring unit of the third embodiment, the holding portion 17 hung on an XY robot (an orthogonal robot having a rail in the orthogonal direction), which is not illustrated, includes a plurality of lifting and lowering mechanisms including the lifting and lowering mechanism 18. The plurality of lifting and lowering mechanisms are capable of lifting and lowering a group of different capillary tubes independently. The group of the capillaries described here may include one single capillary tube, or may include a plurality of the capillary tubes.

The lifting and lowering mechanism 18 is capable of lifting and lowering the first capillary tube 14, and another lifting and lowering mechanism, which is not illustrated, is capable of lowering the group of the capillary tubes including the second capillary tube 15 and the third capillary tube 16. Accordingly, the liquid contact portion 19 is brought into contact with a first liquid by lowering the lifting and lowering mechanism 18 to measure the first liquid, and then the first capillary tube 14 is lifted by the lifting and lowering mechanism 18.

Subsequently, another lifting and lowering mechanism, which is not illustrated, is lowered to bring the liquid contact portion 20 of the second capillary tube 15 and the liquid contact portion 21 of the third capillary tube 16 into contact with a second liquid to measure the second liquid, and the lifting and lowering mechanism lifts the second capillary tube 15 and the third capillary tube 16 to hold the first liquid and the second liquid.

When the second capillary tube 15 and the third capillary tube 16 are connected to the connecting portion 23, a distance between the liquid contact portion 20 of the second capillary tube 15 and the holding portion 17 and a distance between the liquid contact portion 21 of the third capillary tube and the holding portion 17 are preferably the same. The reason is that liquid can be measured by the second capillary tube and the third capillary tube simultaneously by lifting and lowering the lifting and lowering mechanism, which is not illustrated, if the distance is the same.

A connecting part between the first capillary tube and the discharge mechanism, a connecting part between the second capillary tube and the discharge mechanism, and a connecting part between the third capillary tube and the discharge mechanism are integrated in the interiors of the connecting portions 22 and 23 with respect to the lifting and lowering mechanism.

The liquid supplying apparatus having the liquid measuring unit of the third embodiment includes the liquid measuring unit of the third embodiment, a lifting and lowering mechanism configured to control the lifting and lowering mechanism, a discharge mechanism connected to the connecting portion, and a discharge mechanism control unit configured to control the discharge mechanism. Measurement of liquid is achieved by lifting and lowering the tube or the group of tubes selected by the lifting and lowering control unit.

The discharge mechanism, which is not illustrated, the discharge mechanism control unit, the lifting and lowering mechanism, and the lifting and lowering mechanism control unit are the same as those of the first embodiment, and the connecting portion with respect to the discharge mechanism is the same as that of the first embodiment except that the mechanism capable of coming into contact with the discharging mechanism when the lifting and lowering mechanism 18 is brought into a state of being in contact with the holding portion 17 is provided.

The liquid measuring unit of the third embodiment includes the first lifting and lowering mechanism and the second lifting and lowering mechanism, but the liquid measuring unit may have a configuration in which the first lifting and lowering mechanism and the second lifting and lowering mechanism are not provided and the liquid supplying apparatus includes the first lifting and lowering mechanism and the second lifting and lowering mechanism.

In such a case, the liquid measuring apparatus includes a liquid measuring unit having a first capillary tube, a second capillary tube, and
a third capillary tube present adjacently to the second capillary tube,
a first lifting and lowering mechanism configured to lift and lower the first capillary tube,
a second lifting and lowering mechanism configured to lift and lower the second capillary tube and the third capillary tube simultaneously, and
a holding portion configured to hold the first lifting and lowering mechanism and the second lifting and lowering mechanism.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-240122, filed Nov. 20, 2013 which is hereby incorporated by reference herein in its entirety.

What is claimed is:

1. A liquid measuring unit comprising:
a first capillary tube;
a second capillary tube; and
a holding portion configured to hold the first capillary tube and the second capillary tube,
wherein a distance between a liquid contact portion of the first capillary tube and the holding portion is longer than a distance between a liquid contact portion of the second capillary tube and the holding portion.

2. The liquid measuring unit according to claim 1, wherein
a contact angle of inner peripheral surfaces of the first capillary tube and the second capillary tube with respect to water is greater than 90 degrees, and a contact angle of outer peripheral surfaces of the first capillary tube and the second capillary tube with respect to water is less than 90 degrees.

3. The liquid measuring unit according to claim 1, wherein the first capillary tube and the second capillary tube are provided with connecting portions to be connected to a discharge mechanism on a side opposite to the liquid contact portion.

4. The liquid measuring unit according to claim 1, further comprising:
a third capillary tube, wherein a distance between a liquid contact portion of the third capillary tube and the holding portion is shorter than the distance between the liquid contact portion of the second capillary tube and the holding portion.

5. The liquid measuring unit according to claim 4, wherein the third capillary tube is provided with a connecting portion to be connected to a discharge mechanism on a side opposite to the liquid contact portion.

6. The liquid measuring unit according to claim 1, further comprising:
a third capillary tube, wherein a distance between the liquid contact portion of the third capillary tube and the holding portion is the same as the distance between the liquid contact portion of the first capillary tube or the second capillary tube and the holding portion.

7. The liquid measuring unit according to claim 5, wherein the first capillary tube or the second capillary tube is provided adjacent to the third capillary tube.

8. A liquid supplying apparatus comprising:
a liquid measuring unit, the liquid measuring unit comprising:
a first capillary tube;
a second capillary tube; and
a holding portion configured to hold the first capillary tube and the second capillary tube,
wherein a distance between a liquid contact portion of the first capillary tube and the holding portion is longer than a distance between a liquid contact portion of the second capillary tube and the holding portion, and
wherein the first capillary tube and the second capillary tube are provided with connecting portions to be connected to a discharge mechanism on a side opposite to the liquid contact portion,
a discharge mechanism connected to the connecting portions;
a discharge mechanism control unit configured to control the discharge mechanism;
a lifting and lowering mechanism configured to lift and lower the liquid measuring unit; and
a lifting and lowering control unit configured to control the lifting and lowering mechanism.

9. A liquid measuring unit comprising:
a first capillary tube;
a second capillary tube; and
a holding portion configured to hold the first capillary tube and the second capillary tube and including a rotary mechanism configured to rotate the first capillary tube and the second capillary tube.

10. The liquid measuring unit according to claim 9, wherein
a contact angle of inner peripheral surfaces of the first capillary tube and the second capillary tube with respect to water is greater than 90 degrees, and a contact angle of outer peripheral surfaces of the first capillary tube and the second capillary tube with respect to water is less than 90 degrees.

11. The liquid measuring unit according to claim 9, wherein the rotary mechanism is configured to rotate the first capillary tube and the second capillary tube about a center axis of the rotary mechanism.

12. The liquid measuring unit according to claim 9, wherein the first capillary tube and the second capillary tube each include a connecting portion to be connected to a discharge mechanism on a side opposite to the liquid contact portion.

13. A liquid supplying apparatus comprising:
a liquid measuring unit, the liquid measuring unit comprising:
a first capillary tube;
a second capillary tube; and
a holding portion configured to hold the first capillary tube and the second capillary tube and including a rotary mechanism configured to rotate the first capillary tube and the second capillary tube,
wherein the first capillary tube and the second capillary tube each include a connecting portion to be connected to a discharge mechanism on a side opposite to the liquid contact portion.
a lifting and lowering mechanism configured to lift and lower the liquid measuring unit;
a rotation control unit configured to control the rotary mechanism;
a discharge mechanism connected to each connecting portion; and
a discharge mechanism control unit configured to control the discharge mechanism.

14. A liquid measuring unit comprising:
a first capillary tube;
a second capillary tube;
a third capillary tube adjacent to the second capillary tube;
a first lifting and lowering mechanism configured to lift and lower the first capillary tube;
a second lifting and lowering mechanism configured to lift and lower the second capillary tube and the third capillary tube; and
a holding portion configured to hold the first lifting and lowering mechanism and the second lifting and lowering mechanism.

15. The liquid measuring unit according to claim 14, wherein
a contact angle of inner peripheral surfaces of the first capillary tube, the second capillary tube, and the third capillary tube with respect to water is greater than 90 degrees, and a contact angle of outer peripheral surfaces of the first capillary tube, the second capillary tube, and the third capillary tube with respect to water is less than 90 degrees.

16. The liquid measuring unit according to claim 14, wherein the first capillary tube, the second capillary tube, and the third capillary tube each include a connecting portion to be connected to a discharge mechanism on a side opposite to the liquid contact portion.

17. A liquid supplying apparatus comprising:
a liquid measuring unit, the liquid measuring unit comprising:
a first capillary tube;
a second capillary tube;
a third capillary tube adjacent to the second capillary tube;
a first lifting and lowering mechanism configured to lift and lower the first capillary tube;
a second lifting and lowering mechanism configured to lift and lower the second capillary tube and the third capillary tube; and
a holding portion configured to hold the first lifting and lowering mechanism and the second lifting and lowering mechanism,
wherein the first capillary tube, the second capillary tube, and the third capillary tube each include a connecting portion to be connected to a discharge mechanism on a side opposite to the liquid contact portion.
a lifting and lowering mechanism control unit configured to control the first and second lifting and lowering mechanisms;
a discharge mechanism connected to each connecting portion; and
a discharge mechanism control unit configured to control the discharge mechanism.

18. A liquid supplying apparatus comprising:
a liquid measuring unit, the liquid measuring unit including:
a first capillary tube;
a second capillary tube; and
a third capillary tube present adjacently to the second capillary tube;
a first lifting and lowering mechanism configured to lift and lower the first capillary tube;
a second lifting and lowering mechanism configured to lift and lower the second capillary tube and the third capillary tube; and
a holding portion configured to hold the first lifting and lowering mechanism and the second lifting and lowering mechanism.
